(19) United States
(12) Patent Application Publication
(10) Pub. No.: US 2024/0424469 A1
(43) Pub. Date: Dec. 26, 2024

(54) SYSTEM AND METHOD FOR GENERATION OF NANOPARTICLES USING ULTRASONIC ENERGY

(71) Applicant: Unique Equipment Solutions LLC, Littleton, MA (US)

(72) Inventors: John F. McNamara, Sterling, MA (US); Thomas A. Cellucci, Chantilly, VA (US); Paul A. Routhier, Littleton, MA (US); Mykola A. Kostenko, Littleton, MA (US)

(21) Appl. No.: 18/662,221

(22) Filed: May 13, 2024

Related U.S. Application Data
(60) Provisional application No. 63/465,815, filed on May 11, 2023.

(51) Int. Cl. B01J 19/10; B01J 19/00; B01J 19/06

(52) U.S. Cl. CPC B01J 19/10; B01J 19/0006; B01J 19/06; B01J 2219/0801; B01J 2219/0869; B01J 2219/089

(57) ABSTRACT

A system for manufacturing nanoparticles from a material is provides. It comprises a solution provided in a circulating conduit arrangement. A reaction chamber receives the solution at an inlet having an ultrasonic generator that projects ultrasonic energy into a wire mesh of the material, and directs the solution with particles of the material formed by the ultrasonic energy to an outlet. A mixer receives the solution from the outlet and a circulation pump biases the mixed solution in a circulating manner. A control processor operates the ultrasonic generator and a circulation pump to maintain a flow of the solution as ultrasonic energy is projected onto the wire mesh and particles. The material can comprise a metal, metal alloy, carbon compounds and/or silicon compounds. The mixer can include a powered agitator, and/or the conduit arrangement can be adapted to allow collection of the nanoparticles for transfer to a storage location.

### RELATED APPLICATION

This application claims the benefit of U.S. Provisional Application Ser. No. 63/465,815, entitled SYSTEM AND METHOD FOR GENERATION OF NANOPARTICLES USING ULTRASONIC ENERGY, filed May 11, 2023, the teachings of which are expressly incorporated herein by reference.

### FIELD OF THE INVENTION

This invention relates to systems and methods for manufacturing nanoparticles from metal and other appropriate materials.

### BACKGROUND OF THE INVENTION

A nanoparticle is typically characterized as a particle that is between 1 and 100 nanometres (nm) in diameter. Nanoparticles are usually distinguished from microparticles (1-1000 μm), “fine particles” (sized between 100 and 2500 nm), and “coarse particles” (ranging from 2500 to 10,000 nm), because their smaller size implicates unique physical or chemical properties, like colloidal properties and ultrafast optical effects, and/or various electrical properties. Being more subject to the brownian motion, nanoparticles typical resist sedimentation. Being much smaller than the wavelengths of visible light (400-700 nm), nanoparticles generally cannot be visualized with ordinary optical microscopes, thus requiring the use of electron microscopes or laser-based optics.

The properties of nanoparticles often differ markedly from those of larger particles of the same material. Since the typical diameter of an atom is between 0.15 and 0.6 nm, a large fraction of the nanoparticle's material lies within a few atomic diameters of its surface. Therefore, the properties of that surface layer may dominate over those of the bulk material. This effect is particularly strong for nanoparticles dispersed in a medium of different composition since the interactions between the two materials at their interface also becomes significant.

Nanoparticles occur widely in nature and are objects of study in many sciences such as chemistry, physics, geology and biology. Being at the transition between bulk materials and atomic or molecular structures, they often exhibit phenomena that are not observed at either scale. They are an important component in many industrialized products such as paints, plastics, metals, ceramics, and magnetic products. The production of nanoparticles with specific properties is a branch of nanotechnology.

As the most prevalent morphology of nanomaterials used in consumer products, nanoparticles have an enormous range of potential and actual applications. For example, nanoparticles are being investigated as potential drug delivery system. Drugs, growth factors or other biomolecules can be conjugated to nanoparticles to aid targeted delivery. This nanoparticle-assisted delivery allows for spatial and temporal controls of the loaded drugs to achieve the most desirable biological outcome. Nanoparticles are also studied for possible applications as dietary supplements for delivery of biologically active substances, for example mineral elements. Nanoparticles, when incorporated into polymer matrices, increase reinforcement, leading to stronger plastics, verifiable by a higher glass transition temperature and other mechanical property tests. These nanoparticles impart their (hardening) properties to a polymer (plastic). Nanoparticles have also been attached to textile fibers in order to create smart and functional clothing. The inclusion of nanoparticles in a solid or liquid medium can substantially change its mechanical properties, such as elasticity, plasticity, viscosity, compressibility.

Additionally, being smaller than the wavelengths of visible light, nanoparticles can be dispersed in transparent media without affecting its transparency at those wavelengths. This property is exploited in many applications, such as photocatalysis. Moreover, certain large-scale construction tasks, such as road paving and concrete forming, can benefit from use of nanoparticles. For example, asphalt modification through nanoparticles can be used to provide novel perspectives in making asphalt materials more durable. It is well known that a variety of other applications exist for nanoparticles, and more particularly metal nanoparticles across a very wide range of technical fields.

At present, manufacturing of nanoparticles can be costly, and yields/quality can be low relative to input energy and material costs. Hence, it is desirable to provide systems and methods for manufacturing of nanoparticles from various materials with reduced cost, and increased yield and quality.

### SUMMARY OF THE INVENTION

This invention overcomes disadvantages of the prior art by providing a system and method for manufacturing nanoparticles that uses ultrasonic energy, projected on a specialized wire mesh in solution, to form a stream of nanoparticles in the solution. The process includes a circulation pump to allow for continuous breakdown of both larger particles in solution and the wire mesh into nanoparticles of a desired size range.

In an illustrative embodiment, a system for manufacturing nanoparticles from a material can, more particularly, comprises a solution provided in a circulating conduit arrangement, and a reaction chamber that receives the solution at an inlet having an ultrasonic generator that projects ultrasonic energy into a wire mesh of the material, and directs the solution with particles of the material formed by the ultrasonic energy to an outlet. A mixer receives the solution from the outlet and a circulation pump biases the mixed solution into the inlet in a circulating manner. A control processor operates the ultrasonic generator and a circulation pump to maintain a flow of the solution as ultrasonic energy is projected onto the wire mesh and particles therein. Illustratively, the material can comprise one of a metal, metal alloy, carbon compounds and silicon compounds. The mixer can include a powered agitator, and/or the conduit arrangement can be adapted to allow collection of the nanoparticles for transfer to a storage location. The system and method can further include a process gas inlet that is adapted to inject gas under pressure into the conduit arrangement. The process gas inlet can be provided in connection with the mixer, and/or can include a valve responsive to the process controller. Illustratively, the solution can comprise pure water or water with small amounts of common miscible organic solvents, in which the organic solvents can include at least one of methanol, ethanol, propanol, acetone, and glycols. The wire of the wire mesh can define a size in a range of AWG 30 to AWG 40, and more particularly, AWG 39 to AWG 40. The ultrasonic energy can be produced/generated with a frequency of at least, approximately 22 KHz and a power of at least 400 W to 2000 W.

### BRIEF DESCRIPTION OF THE DRAWINGS

The invention description below refers to the accompanying drawings, of which:

FIG. 1 is a schematic diagram showing a generalized arrangement for manufacturing metal (or other material) nanoparticles using high-ultrasonic energy in a continuous process according to an illustrative embodiment; and

FIG. 2 is a schematic diagram showing a generalized arrangement for manufacturing metal (or other material) nanoparticles using high-ultrasonic energy in a continuous process, according to another illustrative embodiment.

### DETAILED DESCRIPTION

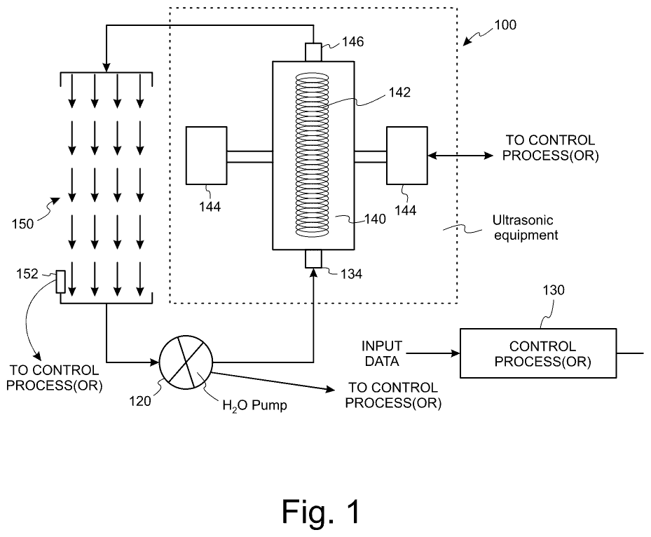

FIG. 1 depicts a manufacturing arrangement 100 for producing nanoparticles from an appropriate material. Such material(s) can include, but are not limited to, pure and alloyed metals, such as iron, steel, copper, aluminum, titanium, cobalt, nickel, silver, etc. and/or graphite/graphene/carbon compounds, silicon compounds, etc. In the depicted arrangement 100, a water-based solution, consisting of either pure water or with small amounts of common miscible organic solvents. Examples include but are not limited to methanol, ethanol, propanol, acetone, and glycols., is provided by a pump 120 under at a predetermined timing and flow rate under control of a control process (or)/process controller 130. The solution enters the inlet 134 of a reaction chamber 140 that is provided with a mesh and/or other collection 142 or relatively thin wires of the material. By way of non-limiting example, the thickness of the wires can be in a range of AWG 30 to 40, and more particularly, AWG 39 to 40. The mesh 142 is subjected to a high-frequency (high-energy) ultrasonic generator assembly 144 under control of the process controller 130. In a non-limiting example, the ultrasonic waves produced by the source 144 can be characterized by a frequency of at least 22 KHz and a power of at least 400 W, with 1200 to 2000 W acceptable.

The ultrasonic energy applied to the mesh 142 generates nanoparticles of desired size (for example, as small as 1 nm) in a continuous process. The solution carries generated particles out of the chamber via an outlet 146. The solution carrying nanoparticles is directed to a mixing unit 150 where nanoparticles of a desired size, and smaller, can be (optionally) collected from the solution using techniques and processes known to those of skill. The remaining solution exits the mixing unit 150 flows back (plus any makeup solution) into the reaction chamber 140 under the bias of the pump 120. A sensor/control probe 152 can provide information on the solution flow back to the control processor 130 at this and other locations (not shown) along the arrangement 100. The reentry of solution into the reaction chamber 140 allows larger particles (still in solution) to be further broken down by the ultrasonic energy applied thereto while the mesh 142 continues to be reacted by the energy. Eventually, the mesh is sufficiently exhausted and the arrangement is drained to remove any particles, separating by size using appropriate filtration techniques.

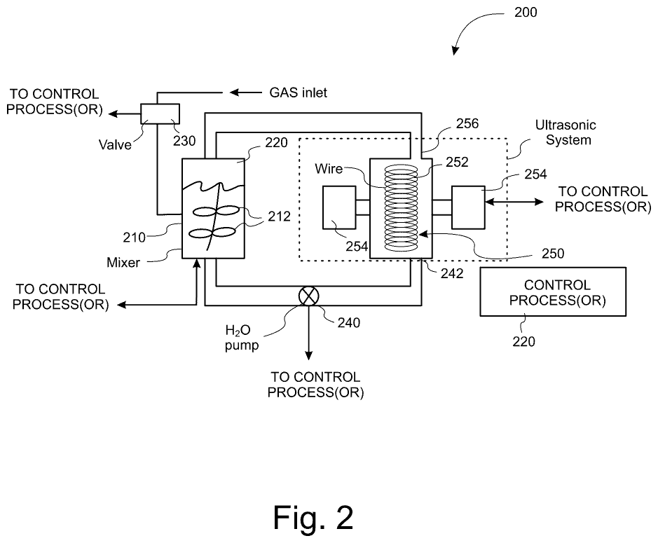

FIG. 2 shows an arrangement 200 for manufacturing nanoparticles according to an alternate embodiment. A water-based solution is provided to a mixing assembly 210 that can have an appropriate, motor-driven agitator 212 under control of a control process (or) (process controller) 220. The mixer can also receive an appropriate inert (or other) process gas under pressure. For example, helium, argon, neon, krypton, nitrogen, methane, and/or combinations thereof. The gas can form a headspace 222 in the mixer 210. It is regulated by a valve 230 under control of the process controller 220.

The mixer 210 directs solution (and process gas) through an appropriate fluid pump 240, controlled by the process controller 220 for timing and flow rate. The solution enters an inlet 242 of a reaction chamber 250 that can operate on similar (or modified) principles relative to the chamber 140 described above. The reaction chamber 250 includes a mesh of wire 252 consisting of the selected material from which nanoparticles are to be formed. The chamber 250 receives high-frequency/high-amplitude (high-energy) ultrasonic waves from an ultrasonic generator assembly 254 under control of the process controller 220. These waves break down the wire into particles that flow out of the outlet 256. The solution is thereafter returned to the mixer 210 and back into the reaction chamber so particles contained therein can be further broken down to eventually yield appropriately sized nanoparticles, while the wire mesh 252 is further consumed.

Various pressure and/or flow sensors (not shown) can be provided in the fluid circuit of the arrangement 200, and provide feedback to the process controller 220. Makeup solution and gas can be injected into the system as required based upon appropriate flow and/or level sensors located, for example, adjacent to the mixer 210.

When the material in the reaction chamber is sufficiently broken down and/or the solution contains a sufficient quantity of nanoparticles displaying a desired size range, then the arrangement 200 can be drained, and the nanoparticles collected using know techniques for filtration.

It should be clear that the above-described systems and methods for manufacturing nanoparticles of a desired size range can employ relatively inexpensive and long-running, commercially available components to break down materials. The process can produce nanoparticles in a somewhat continuous manner until feed stock material (e.g. wire mesh) is exhausted. The system can be readily serviced and placed back into production with minimal downtime.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, as used herein, the terms “process” and/or “processor” should be taken broadly to include a variety of electronic hardware and/or software based functions and components (and can alternatively be termed functional “modules” or “elements”). Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Additionally, as used herein various directional and dispositional terms such as “vertical”, “horizontal”, “up”, “down”, “bottom”, “top”, “side”, “front”, “rear”, “left”, “right”, and the like, are used only as relative conventions and not as absolute directions/dispositions with respect to a fixed coordinate space, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Accordingly, this description is meant to be taken only by way of example, and not to otherwise limit the scope of this invention.

What is claimed is:

1. A system for manufacturing nanoparticles from a material comprising:
a solution provided in a circulating conduit arrangement;
a reaction chamber receiving solution at an inlet having an ultrasonic generator that projects ultrasonic energy into a wire mesh of the material, and the solution with particles of the material formed by the ultrasonic energy being received at an outlet;
a mixer that receives the solution from the outlet and a circulation pump that biases the mixed solution into the inlet in a circulating manner; and
a control processor that operates the ultrasonic generator and a circulation pump to maintain a flow of the solution as ultrasonic energy is projected onto the wire mesh and particles therein.

2. The system as set forth in claim 1, wherein the material comprises one of a metal, metal alloy, carbon compounds and silicon compounds.

3. The system as set forth in claim 2, wherein the mixer includes a powered agitator.

4. The system as set forth in claim 2, wherein the conduit arrangement is adapted to allow collection of the nanoparticles for transfer to a storage location.

5. The system as set forth in claim 4, further comprising, a process gas inlet that is adapted to inject the process gas under pressure into the conduit arrangement.

6. The system as set forth in claim 5, wherein the process gas inlet is provided in connection with the mixer.

7. The system as set forth in claim 6, wherein the process gas inlet includes a valve responsive to the process controller.

8. The system as set forth in claim 1, wherein the solution comprises pure water or water with small amounts of common miscible organic solvents.

9. The system as set forth in claim 8, wherein the organic solvents include at least one of methanol, ethanol, propanol, acetone, and glycols.

10. The system as set forth in claim 1, wherein wire in the wire mesh defines a size of either AWG 30 to AWG 40 or AWG 39 to AWG 40.

11. The system as set forth in claim 1, wherein the ultrasonic energy is produced with a frequency of at least, approximately 22 KHz and a power of at least 400 W to 2000 W.

12. A method for manufacturing nanoparticles from a material comprising the steps of:
providing a solution in a circulating conduit arrangement;
receiving the solution at an inlet of a reaction chamber having an ultrasonic generator that projects ultrasonic energy into a wire mesh of the material, and directing the solution with particles of the material formed by the ultrasonic energy to an outlet;
receiving, at a mixer, the solution from the outlet and a circulation pump, and biasing the mixed solution into the inlet in a circulating manner; and
operating, with a control processor, the ultrasonic generator and a circulation pump to maintain a flow of the solution as ultrasonic energy is projected onto the wire mesh and particles therein.

13. The method as set forth in claim 12, wherein the material comprises one of a metal, metal alloy, carbon compounds and silicon compounds.

14. The method as set forth in claim 13, further comprising, collecting, with the conduit arrangement, the nanoparticles for transfer to a storage location.

15. The method as set forth in claim 14, further comprising, injecting, via a process gas inlet, the process gas under pressure into the conduit arrangement.

16. The method as set forth in claim 15, further comprising, connecting the process gas inlet with the mixer, and providing, at the process gas inlet, a valve responsive to the process controller.

17. The method as set forth in claim 12, wherein the solution comprises pure water or water with small amounts of common miscible organic solvents.

18. The method as set forth in claim 17, wherein the organic solvents include at least one of methanol, ethanol, propanol, acetone, and glycols.

19. The method as set forth in claim 12, wherein wire in the wire mesh defines a size of either AWG 30 to AWG 40 or AWG 39 to AWG 40.

20. The method as set forth in claim 12, further comprising, producing the ultrasonic energy with a frequency of at least, approximately 22 KHz and a power of at least 400 W to 2000 W.
